(19) United States
(12) Patent Application Publication
(10) Pub. No.: US 2013/0016125 A1
(43) Pub. Date: Jan. 17, 2013

(54) METHOD FOR ACQUIRING AN ANGLE OF ROTATION AND THE COORDINATES OF A CENTRE OF ROTATION

(71) Applicant: Jean-François Mainguet, Grenoble (FR)

(72) Inventor: Jean-François Mainguet, Grenoble (FR)

(73) Assignee: Commissariat a l'energie atomique et aux energies alternatives, Paris (FR)

(21) Appl. No.: 13/548,379

(22) Filed: Jul. 13, 2012

(30) Foreign Application Priority Data
Jul. 13, 2011 (FR) 1156445

(51) Int. Cl. G09G 5/00; G06K 9/32

(52) U.S. Cl. 345/649; 382/296

(57) ABSTRACT

This method for acquiring an angle of rotation and the coordinates of a centre of rotation, comprises:
the selection (68, 84) in a first image of N different groups Gᵢ of pixels, these groups Gᵢ of pixels being aligned along one and the same alignment axis and each group Gᵢ being associated with a respective ordinate xᵢ along this axis,
for each group Gᵢ, the computation (72) of a displacement yᵢ of the group Gᵢ between the first and second images in a direction perpendicular to the alignment axis,
the computation (86) of the angle of rotation and of the coordinates of the centre of rotation on the basis of the coefficients “a” and “b” of a linear regression line which minimizes the following relation:

$${\sum }_{i = 1}^{i = N} ‖ {y}_{i} - {ax}_{i} - b ‖$$

where N is a whole number of groups Gᵢ, N being greater than or equal to three.

### CROSS-REFERENCE TO RELATED APPLICATIONS

Under 35 USC 119, this application claims the benefit of the priority date of French Patent Application 1156445, filed Jul. 13, 2011, the contents of which are herein incorporated by reference.

### FIELD OF DISCLOSURE

The invention relates to a method for acquiring an angle of rotation and the coordinates of a centre of rotation. The subject of the invention is also a method for controlling a screen and a medium for recording information for the implementation of these methods. The invention also relates to an apparatus equipped with a screen and able to implement this method of control.

### BACKGROUND

Known methods for acquiring an angle of rotation and the coordinates of a centre of rotation comprise:
the acquisition by an electronic sensor of a first image of a pattern before its rotation about an axis perpendicular to the plane of the image,
the rotation of the pattern with respect to the electronic sensor, by a human being, about the axis perpendicular to the plane of the image,
the acquisition by the electronic sensor of a second image of the same pattern after this rotation, these images being formed of pixels recorded in an electronic memory,
   the selection, by an electronic computer, in the first image of N different groups Gᵢ of pixels, these groups Gᵢ of pixels being aligned along one and the same alignment axis and each group Gᵢ being associated with a respective ordinate xᵢ along this axis, the index i identifying the group Gᵢ from among the N groups Gᵢ of pixels,
for each group Gᵢ, the computation, by the electronic computer, of a displacement yᵢ of the group Gᵢ between the first and second images in a direction perpendicular to the alignment axis by comparing the first and second images, the value of the displacement yᵢ being obtained by computation of correlation between pixels of the first image belonging to the group Gᵢ and pixels of the second image.

For example, such a method is disclosed in patent application U.S. 2005/0012714. This method is particularly simple and therefore requires limited computing power in order to be implemented. It can therefore be implemented in electronic apparatuses having limited computer resources such as portable electronic apparatuses and notably personal assistants or mobile telephones.

However, in this method, the angle of rotation is determined with mediocre precision. Indeed, the angle of rotation may be computed precisely only with respect to a centre of rotation. In patent application U.S. 2005/0012714, no procedure for precisely determining the position of the centre of rotation is disclosed. More precisely, in this patent application, the position of the centre of rotation is assumed to be at the intersection between two windows, that is to say substantially in the middle of the electronic sensor. Now, such an assumption does not account correctly for the actual position of the centre of rotation. Because of the lack of precision in the determination of the position of the centre of rotation, the angle of rotation computed is also not very precise.

Generally, the precise determination of the position of the centre of rotation is a difficult thing. Indeed, by definition, the amplitudes of the displacements of the pattern in proximity to the centre of rotation are small and therefore exhibit a mediocre signal/noise ratio. Thus, other procedures for acquiring an angle of rotation and the coordinates of the centre of rotation have been envisaged. For example, it is possible to refer to patent application U.S. 2001/0036299. However, these procedures call upon complex computations on the images acquired which require significant computing power. They can therefore only be implemented on apparatuses having significant computer resources.

Prior art is also known from:
U.S. Pat. No. 5,563,403A,
U.S. Pat. No. 4,558,461A,
JP10027246A.

### SUMMARY

The invention is aimed at remedying this drawback by proposing a method which is both precise and simple for acquiring the angle of rotation and the coordinates of the centre of rotation in such a way that this method can be implemented on apparatuses of limited computing power.

Its subject is therefore a method in accordance with Claim 1.

The method hereinabove is based on the assumption that if the groups Gᵢ of pixels are aligned with the alignment axis M before the rotation, then after the rotation, they must also be aligned with an axis M′ which makes an angle “a” with the axis M, the angle “a” being the angle of rotation. Moreover, the intersection between the axes M and M′ corresponds to the centre of rotation. Indeed, a simple rotation must not modify the alignment of the groups G. Consequently, the coefficients “a” and “b”, computed by linear regression, make it possible to obtain the equation of the axis M′ and therefore the angle of rotation and the coordinates of the centre of rotation. The fact that the coefficients “a” and “b” are computed by linear regression makes it possible to take into account and to compensate in the best way for spurious phenomena such as:
the misalignment of the groups Gᵢ after the rotation, caused by the elastic deformation of the material in which the pattern is produced, and
the existence of a translation of the pattern, simultaneous with its rotation.

In the method hereinabove, no particular knowledge is necessary regarding what the pixels of the groups Gi represent since the displacement yᵢ is computed by correlation between the pixels of the first image belonging to the group Gᵢ and the pixels of the second image. Thus, the method described applies to any pattern having no symmetry of revolution.

The method hereinabove makes it possible to determine much more precisely the angle of rotation and the coordinates of the centre of rotation than the method described in patent application U.S. 2005/0012714. For example, the method hereinabove does not require any assumption regarding the position of the centre of rotation and in particular does not require that the ordinate of the centre of rotation be at the limit between two groups Gᵢ of pixels, as is the case in patent application U.S. 2005/0012714.

Moreover, the method hereinabove uses only N groups Gᵢ of pixels aligned with one and the same axis. Thus, it is not necessary to carry out the computations on all the pixels of the image. This limits the number of operations to be carried out and therefore decreases the computing power necessary to implement this method.

The fact that the coefficients “a” and “b” are computed by linear regression also simplifies the computations and also limits the computing power necessary for the implementation of this method.

Therefore, the method hereinabove is particularly fast to execute and does not require significant computing power in order to be implemented in a reasonable time.

The embodiments of this method can comprise one or more of the characteristics of the dependent claims.

These embodiments of this method can furthermore exhibit the following advantages:
using solely the pixels of a window to compute the angle of rotation and the centre of rotation makes it possible to reduce the number of operations to be carried out and therefore the computing power necessary to implement this method;
acquiring only the pixels contained in this window makes it possible to increase the acquisition speed and to decrease the electrical consumption of the electronic sensor;
splitting the window into N sectors Sᵢ also makes it possible to reduce the number of operations to be carried out in order to compute the angle and the coordinates of the centre of rotation;
not taking the displacement yᵢ and the ordinate xᵢ into account if the displacement yᵢ exceeds a predetermined threshold makes it possible to eliminate the aberrant points and therefore to raise the precision of the computation without increasing the number of operations to be carried out;
adjusting the time interval between the acquisition of the first and second images as a function of a previously computed angle, in order to keep this angle between 0.5° and 10°, makes it possible to increase the precision of the method since for these values of angle of rotation the first and second images overlap sufficiently to compute the displacements yᵢ precisely.

The subject of the invention is also a method for controlling a display screen, this method comprising:
the control, by an electronic computer, of the screen so as to rotate an object displayed on this screen as a function of an angle of rotation acquired and of the coordinates of a centre of rotation, and
the acquisition of the angle of rotation by implementing the method hereinabove.

The subject of the invention is also a medium for recording information, comprising instructions for the execution of the method hereinabove when these instructions are executed by an electronic computer.

The subject of the invention is also an apparatus in accordance with Claim 9.

The embodiments of this apparatus can comprise the following characteristic:
the electronic sensor is a fingerprint sensor or an optical mouse.

### BRIEF DESCRIPTION OF THE FIGURES

The invention will be better understood on reading the description which follows, given solely by way of nonlimiting example and with reference to the drawings in which:

FIG. 1 is a schematic illustration of an apparatus able to acquire an angle of rotation and the coordinates of a centre of rotation;

FIG. 2 is a schematic illustration of an electronic sensor used in the apparatus of FIG. 1;

FIG. 3 is a schematic and partial illustration of the distribution of pixels of the electronic sensor of FIG. 2 on a sensitive face;

FIG. 4 is a flowchart of a method for acquiring an angle of rotation and the coordinates of a centre of rotation;

FIGS. 5 and 6 are schematic illustrations of processing implemented to execute the method of FIG. 4; and

FIG. 7 is a schematic illustration of a pixel window split into several sectors and used by the method of FIG. 4.

In these figures, the same references are used to designate the same elements.

### DETAILED DESCRIPTION

Hereinafter in this description, the characteristics and functions well known to the person skilled in the art are not described in detail.

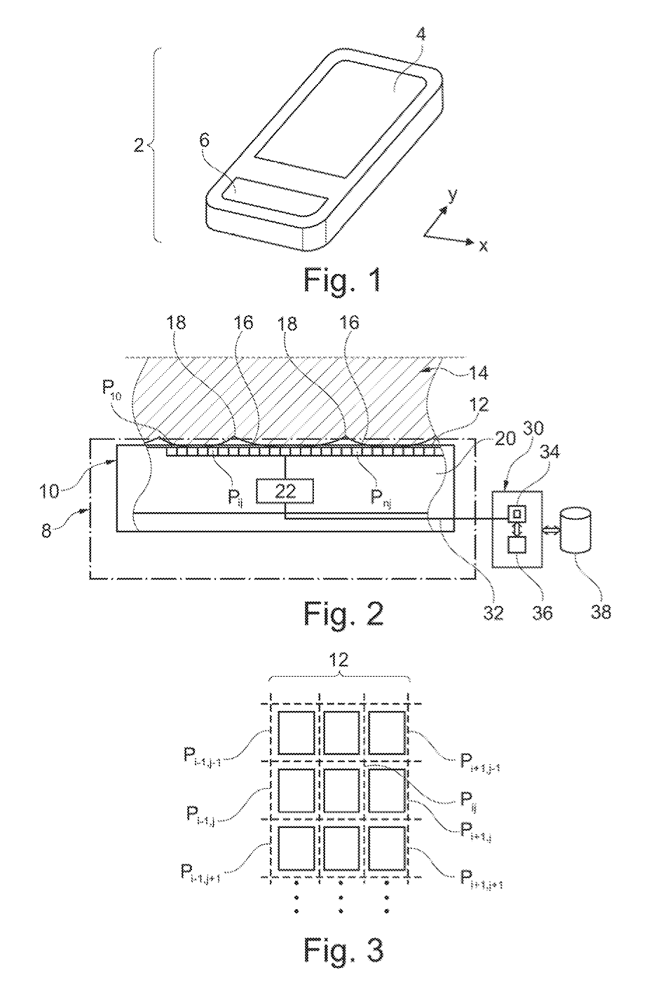

FIG. 1 represents an electronic apparatus 2 able to acquire an angle of rotation and the coordinates of a centre of rotation. For this purpose, it is equipped, by way of example, with a screen 4 and with a tactile man-machine interface 6. The interface 6 is for example used to displace an object displayed on the screen 4. In this description, we are more particularly concerned with the rotational displacement of the object displayed on the screen 4. To rotationally displace an object displayed on the screen 4, it is necessary that an angle of rotation θ and coordinates C of a centre of rotation be acquired beforehand via the interface 6.

In this embodiment, accordingly, the user places his finger at the location of the desired centre of rotation on the interface 6 and then rotates his finger about an axis perpendicular to the surface of the interface 6 to indicate the desired value of the angle θ. In this embodiment, this manoeuvre allows the user in particular to indicate the position of the centre of rotation in the direction X.

The finger of a user bears a pattern devoid of symmetry of revolution so that the angle θ of rotation of this pattern may be detected. Here, this pattern is therefore displaced directly by the user, that is to say a human being. In the case of a finger, this pattern is called a “fingerprint”. The fingerprint is formed of valleys or hollows separated from one another by ridges.

The interface 6 is capable of acquiring an image of the fingerprint with a sufficiently fine resolution to discern the hollows and the ridges.

Here, the image acquired is formed of a matrix of pixels aligned in horizontal rows parallel to a direction X and in columns parallel to a direction Y. To be able to discern the hollows and the ridges, the greatest width in the direction X or Y, of the pixels, is less than 250 μm and, preferably, less than 100 or 75 μm. Advantageously, this greatest width is less than or equal to 50 μm. Here, the pixels are squares 50 μm by 50 μm, thus corresponding to a resolution of about 500 dpi (dots per inch).

FIG. 2 represents in further detail certain aspects of the apparatus 2 and, in particular, a particular embodiment of the tactile man-machine interface 6. In this embodiment, the interface 6 is embodied on the basis of an electronic sensor 8 capable of detecting a thermal pattern.

A thermal pattern is a non-homogeneous spatial distribution of the thermal characteristics of an object that is discernible on the basis of an electronic chip 10 of the sensor 8. Such a thermal pattern is generally borne by an object. In this embodiment, a fingerprint is a thermal pattern detectable by the sensor 8.

The expression “thermal characteristic” denotes the properties of an object which are functions of its thermal capacity and of its thermal conductivity.

Hereinafter in this description, the sensor 8 is described in the particular case where the latter is specially suited to the detection of a fingerprint. In this particular case, the sensor 8 is better known by the term fingerprint sensor.

The chip 10 exhibits a sensitive face 12 to which the object incorporating the thermal pattern to be charted must be applied. Here, this object is a finger 14 whose epidermis bears directly on the face 12. The fingerprint present on the epidermis of the finger 14 is manifested by the presence of ridges 16 separated by hollows 18. In FIG. 2, the finger 14 is enlarged several times so as to render the ridges 16 and the hollows 18 visible.

When the finger 14 bears on the face 12, only the ridges 16 are directly in contact with the face 12. Conversely, the hollows 18 are isolated from the face 12 by air. Thus, the thermal conductivity between the finger and the face 12 is better at the level of the ridges 16 than at the level of the hollows 18. A fingerprint therefore corresponds to a thermal pattern able to be charted by the chip 10.

For this purpose, the chip 10 comprises a multitude of detection pixels Pᵢⱼ disposed immediately alongside one another over the whole of the face 12. A detection pixel Pᵢⱼ is the smallest autonomous surface capable of detecting a temperature variation. The temperature variations detected vary from one pixel to the next depending on whether the latter is in contact with a ridge 16 or opposite a hollow 18. Here, each detection pixel Pᵢⱼ corresponds to a pixel of the image acquired by this sensor. It is for this reason that they are also called “pixels”.

These pixels Pᵢⱼ are produced on one and the same substrate 20.

An exemplary distribution of the pixels Pᵢⱼ alongside one another is represented in FIG. 3. In this example, the pixels Pᵢⱼ are distributed in rows and columns to form a matrix of pixels. For example, the chip 10 comprises at least fifty rows of at least 300 pixels each.

Each pixel defines a fraction of the face 12. Here, these fractions of the face 12 are rectangular and delimited by dashed lines in FIG. 3. The surface of each fraction is less than 1 mm² in area and, preferably, less than 0.5 or 0.01 or 0.005 mm². Here, the fraction of the face 12 defined by each pixel Pᵢⱼ is a square 50 μm by 50 μm. The distance between the geometric centre of two contiguous pixels is less than 1 mm and, preferably, less than 0.5 or 0.1 or 0.01 or 0.001 mm. Here, the distance between the centres of the contiguous pixels Pᵢⱼ is equal to 50 μm.

Each pixel comprises:
a transducer capable of transforming a temperature variation into a difference in potentials, and optionally
a heating resistor capable of heating the object in contact with this transducer.

The difference in potentials represents “the measurement” of the temperature variation in the sense that, after calibration, this difference in potentials may be converted directly into a temperature variation.

The heating resistor makes it possible to implement an active detection method like that described in the patent application published under the number U.S. Pat. No. 6,091,837 or the patent application filed under the number FR1053554 on 6 May 2010.

Active detection methods exhibit several advantages including in particular the fact of being able to operate even if the initial temperature of the pixels is close or identical to that of the object bearing the thermal pattern. It is also possible to adjust the contrast by controlling the quantity of heat dissipated by the heating resistor of each pixel.

Each pixel Pᵢⱼ is connected electrically to a circuit 22 for reading the temperature variation measurements carried out by each of these pixels. More precisely, the circuit 22 is able:
to select one or more pixels Pᵢⱼ to be read,
to control the heating resistor of the selected pixel or pixels, and
to read the temperature variation measured by the transducer of the selected pixel or pixels.

Typically, the reading circuit is etched and/or deposited in the same rigid substrate 20 as that on which the pixels Pᵢⱼ are produced. For example, the substrate 20 is made of silicon or glass.

The sensor 8 is connected to an electronic computer 30 by a wire link 32. For example, this computer 30 is equipped with a module 34 for driving the chip 10 and a processing module 36.

The module 34 makes it possible to chart the thermal pattern on the basis of the measurements of the detection pixels. More precisely, this module is capable of constructing an image of the ridges and hollows detected by the various pixels as a function of the measurements of the pixels and of the known position of these pixels with respect to one another.

Here, the module 36 is capable, furthermore:
of determining an angle of rotation and the coordinates of the centre of this rotation on the basis of successive images acquired with the aid of the sensor 8, and
of controlling the screen 6 so as to rotate the object displayed as a function of the angle of rotation and of the coordinates of the centre of rotation that were determined.

As a supplement, the module 36 is capable of comparing the image of the fingerprint acquired with images contained in a database so as to identify this fingerprint and, in response, permit and, alternately, prohibit certain actions on the apparatus 2.

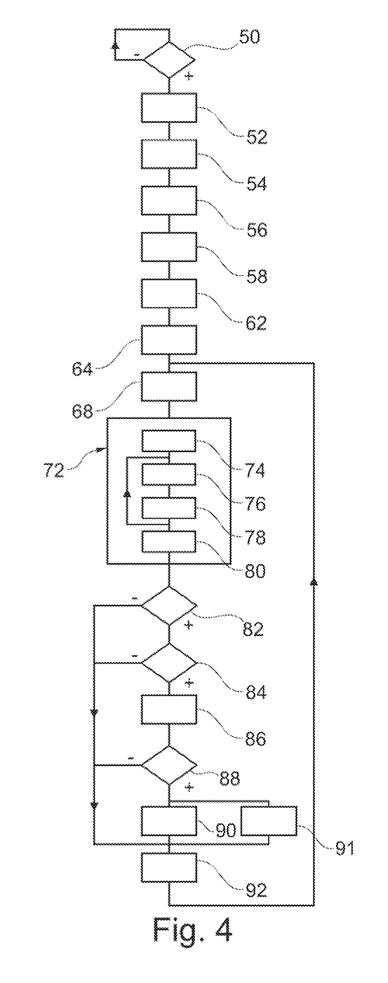

Typically, the computer 30 is embodied on the basis of at least one programmable electronic computer capable of executing instructions recorded on an information recording medium. For this purpose, the computer 30 is connected to a memory 38 containing instructions and the data necessary for the execution of the method of FIG. 4. The images acquired by the sensor 8 are also recorded, by the module 34 in the memory 38.

For other details on the embodying and operation of such a sensor, it is possible to consult, for example, the French patent application filed under the number FR1053554 on 6 May 2010.

The manner of operation of the apparatus 2 will now be described with regard to the method of FIG. 4.

Initially, during a step 50, the computer 30 verifies at regular intervals the presence of a finger placed on the sensitive face 12 of the sensor 8. Accordingly, for example, only a subset of the pixels Pᵢⱼ of the sensor 8 are used so as to decrease the energy consumption of the apparatus 2. Moreover, the verification is done at a not very high frequency. For example, the verification is done between 20 and 25 times per second.

As long as no finger is detected on the face 12, the method remains in step 50.

In the converse case, a step 52 of waking the sensor 8 is undertaken.

Thereafter, during a step 54, the sensor 8 undertakes the acquisition of a first image of the fingerprint at the instant t₁ and then, after a time interval ΔT, the acquisition of a second image of the fingerprint at an instant t₂. Typically, the interval ΔT is sufficiently short such that the first and second images overlap. For example, the interval ΔT is at the minimum equal to 1/800 s and preferably between 1/800 s and 1/400 s by default. The module 34 records these images in the memory 38.

Thereafter, a step 56 of searching for a zone of interest in the first image is undertaken. The zone of interest is the location where the finger touches the face 12. For example, accordingly, the computer 30 selects the pixels where there is some signal. Thereafter, it uses the selected pixels to delimit the zone of interest. Hereinafter, the pixels situated outside of this zone of interest are not used for the computations described hereinbelow. The zone of interest selected may be larger than simply the zone where the finger 14 touches the face 12. On the other hand, the zone of interest is smaller, in terms of number of pixels, than the face 12.

During a step 58, the computer undertakes the coarse locating of the centre of rotation by comparing the first and second images.

For example, each pixel of the zone of interest of the first image is subtracted from the pixel occupying the same position in the second image. A “differential” image is thus obtained. The subtraction of one pixel from another consists in computing the difference between the values measured by the same pixel Pᵢⱼ of the sensor 8 at the instants t₁ and t₂.

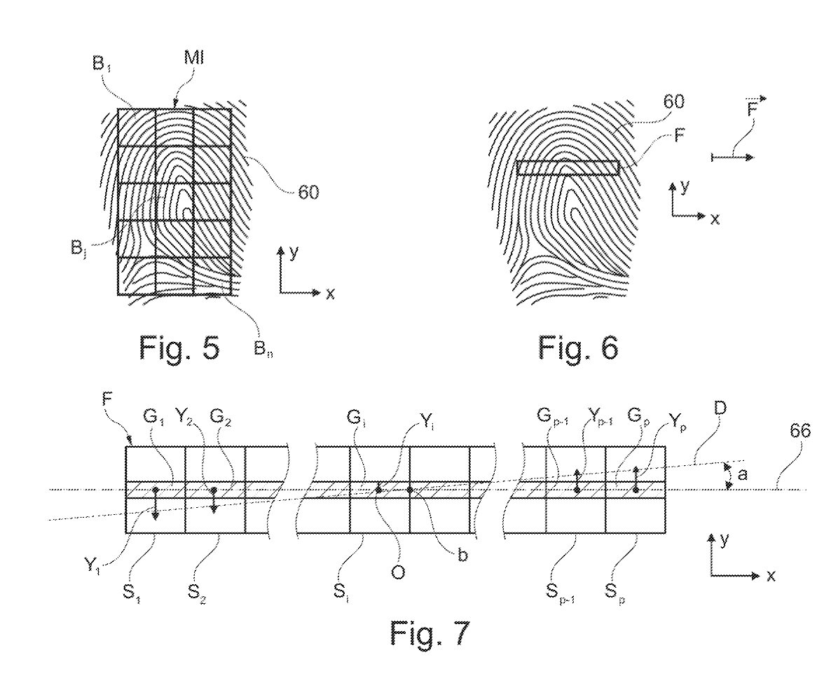

Thereafter, this differential image is divided to form a matrix MI of blocks Bⱼ of pixels. The blocks Bⱼ are immediately contiguous to one another and do not overlap. This matrix MI is represented in FIG. 5. In FIG. 5, the zone of interest is illustrated by a fingerprint 60 represented as a backdrop to the matrix MI. Each block Bⱼ of the matrix MI contains the same number of pixels. Here, each block is a square 8 pixels by 8 pixels. In FIG. 5, the size of the blocks Bⱼ is not to scale with respect to the fingerprint

Thereafter, all the pixels belonging to one and the same block Bⱼ are added up to obtain a mean value of the pixels of this block. The value associated with each pixel of the differential image is the difference between the values of this pixel at the instants t₁ and t₂. It is this value which is added to the values associated with the other pixels of the same block to obtain the mean value of the pixels of this block.

Finally, the computer 30 selects in the guise of centre of rotation the middle of the block Bⱼ which has the smallest mean value. Indeed, the displacements of the fingerprint in proximity to the centre of rotation are much smaller than when far removed from this centre of rotation. Thus, the pixel block which undergoes the least modification between the instants t₁ and t₂ corresponds to the one having the smallest mean value.

During a step 62, the computer 30 positions a window F (see FIG. 6) centred on the approximate position, determined during step 58, of the centre of rotation. This window F is a rectangular window whose length is at least twice and, preferably, at least ten or twenty times as great as its height. For example here, the window F comprises 192 pixels over its length and only 8 pixels over its height.

Only the pixels contained in this window F are used to compute the angle θ and the coordinates C of the centre of rotation. By virtue of this, the number of operations to be carried out is considerably limited with respect to the case where all the pixels of the zone of interest are used for this computation. This therefore renders the execution of the method by the computer 30 much faster and less greedy in terms of computer resources.

The greatest length of the window F extends in a direction F. The direction F is such that two pixels that are immediately adjacent in the direction F are situated at immediately consecutive addresses in the memory 38 where the images are recorded. This facilitates access to the data in memory and accelerates the computations since it is not necessary to compute the memory address of each pixel. It suffices simply to read them in sequence. Here, the direction F is parallel to the horizontal direction X.

During a step 64, the window F is split into P rectangular sectors Sᵢ immediately contiguous to one another in the direction X. The number of sectors is greater than or equal to three and, preferably, greater than or equal to six, ten or twenty. Preferably, the number P is chosen so that the width of each sector Sᵢ in the direction X is between eight pixels and sixteen pixels. Here, the number P is equal to twenty, thus corresponding to a width for each sector Sᵢ of twelve pixels. The index i identifies the sector Sᵢ from among the set of sectors delimited in the window F.

The window F and the sectors Sᵢ are represented in greater detail in FIG. 7. Here, all the sectors Sᵢ are aligned along one and the same horizontal axis 66. In FIG. 7, the vertical wavy lines signify that portions of the window F have been omitted.

During a step 68, the computer 30 selects from each sector Sᵢ of the first image a group Gᵢ of pixels such that all the groups Gᵢ are aligned with one and the same horizontal axis, that is to say here the axis 66. Here, the axis 66 is parallel to the direction X and passes through each sector Sᵢ at mid-height.

For example, each group Gᵢ corresponds to the two rows of twelve pixels situated at mid-height in the direction Y of the sector Sᵢ in the first image. Each group Gᵢ is associated with an ordinate xᵢ along the axis 66. For this purpose, the axis 66 comprises an origin O (FIG. 7) from which the ordinate xᵢ is reckoned. Here, the ordinate xᵢ of each group Gᵢ corresponds to the centre of this group Gᵢ in the direction X.

During a step 72, for each group Gᵢ, the computer 30 computes its vertical displacement yᵢ between the instants t₁ and t₂ by comparing the first and second images. Each displacement yᵢ is contained in the plane of the image and perpendicular to the axis 66. Typically, the displacement yᵢ is obtained through a computation of correlation between the pixels of the sector Sᵢ in the first and second images.

For example, here, the computer searches for the position of the group Gᵢ in the sector Sᵢ of the second image. Accordingly, during an operation 74, the computer constructs a mask Mᵢ which has the same shape as the group Gᵢ of pixels. For example, in this embodiment, the mask Mᵢ corresponds to two horizontal rows, each of twelve pixels. Thereafter, during an operation 76, the computer 30 positions the mask Mᵢ in the sector Sᵢ of the second image after having shifted it by dᵢ pixels in the direction X and by yᵢ pixels in the direction Y.

During a step 78, the computer 30 subtracts each pixel contained in the mask Mᵢ from the corresponding pixel of the group Gᵢ. The corresponding pixel of the group is that which occupies the same position in the mask Mᵢ and in the group Gᵢ. Here, the subtraction of a pixel Pᵢⱼ from a pixel Pₘₙ consists in computing the difference between the value measured by the pixel Pᵢⱼ of the sensor 8 at the instant t₁ and the value measured by the pixel Pₘₙ of the sensor 8 at the instant t₂.

The operations 76 and 78 are repeated for all the possible values of dᵢ and yᵢ. Typically, the displacement dᵢ can take all the values lying between −6 and +5 pixels. The displacement yᵢ can take all the possible values lying between −3 and +4 pixels. Here, the origin of the displacements yᵢ is considered to be on the axis 66.

During an operation 80, the computer selects the pair of values dᵢ, yᵢ which corresponds to the smallest difference computed during the operation 78. Indeed, it is this group of pixels selected by the mask Mᵢ in the second image which correlates best with the group Gᵢ in the first image.

At the end of step 72, the displacements dᵢ and yᵢ of each group Gᵢ are obtained.

During a step 82, the computer 30 verifies that the motion of the finger on the face 12 is indeed a rotation. For example, it computes the average of the displacements dᵢ obtained at the end of the previous step. Thereafter, this value is compared with a predetermined threshold S₁. If this threshold is crossed, the computer considers that the translational motion predominates over the rotational motion. It then undertakes the acquisition of a new second image and the second images previously acquired becomes the first image before returning to step 68.

If the rotational motion predominates, then the method continues via a step 84 of eliminating the aberrant points. The elimination of the aberrant points makes it possible to raise the precision of the computation without increasing the number of computation operations.

During step 84, the computer 30 compares each displacement yᵢ with a predetermined threshold S₂. If the displacement yᵢ is greater than this threshold S₂, then the latter is not taken into account for the computation of the angle θ and the coordinates C of the centre of rotation. For example, here, the threshold S₂ is taken equal to three pixels.

After elimination of the aberrant points, there remain N groups Gᵢ whose displacements yᵢ are taken into account for the computation of the angle θ and the coordinates C.

Moreover, if N is less than or equal to two, then the interval ΔT is decreased. Next, a step of acquiring a new second image is undertaken and the previous second image becomes the first image. Indeed, in this case, it is probable that the rate of rotation of the finger is too fast and that it is therefore necessary to increase the image acquisition frequency in order to remedy this problem.

If N is greater than or equal to three then, during a step 86, the computer 30 computes the angle θ and the coordinates C of the centre of rotation. Accordingly, the computer 30 computes the linear regression line D (FIG. 7) passing through the points with coordinates (xᵢ, yᵢ). Accordingly, it computes the coefficients “a” and “b” which minimize the following relation:

$${\sum }_{i = 1}^{i = N} ‖ {y}_{i} - {ax}_{i} - b ‖$$

where:
yᵢ is the vertical displacement of the group Gᵢ of pixels,
xᵢ is the ordinate of the group Gᵢ, and
∥ . . . ∥ is a norm which gives an absolute value representative of the difference between the displacement yᵢ and axᵢ+b.

During step 86, the aberrant points are not taken into account. Stated otherwise, the groups Gᵢ for which the displacement yᵢ exceeds the threshold S₂ are not taken into account for the computation of the coefficients “a” and “b”. If aberrant points have been eliminated, the number N of groups Gᵢ may be smaller than the number P of sectors Sᵢ or of groups Gᵢ initially selected. However, the number N is always greater than or equal to three.

For example, here, the coefficients “a” and “b” are computed by using the least squares procedure. Consequently, they are computed so as to minimize the following relation:

$${\sum }_{i = 1}^{i = N} {( {y}_{i} - {ax}_{i} - b )}^{2}$$

The angle θ of rotation is then given by the arctangent of the slope “a”. Given that the slope “a” is generally small, to a first approximation the angle θ may be taken equal to the slope “a” thereby simplifying the computations.

The coefficient “b” is the ordinate at the origin and represents the position of the centre of rotation along the axis 66. This position may be converted into coordinates C expressed in another frame of reference on the basis of the known position of the axis 66 in the first image.

During step 86, the computer 30 also computes a precision indicator I representative of the proximity between the points (xᵢ, yᵢ) and the straight line D. This indicator I may be the linear correlation coefficient, the standard deviation, the variance or the like. Here, it is assumed that this indicator I is the standard deviation.

During a step 88, the indicator I is compared with a predetermined threshold S₃. If the indicator I is below this threshold S₃, then this signifies that the deviation between the points (xᵢ, yᵢ) and the straight line D is small and the results are retained. In the converse case, the angle θ computed and the coordinates computed during step 86 are eliminated and the acquisition of a new image to replace the second image is undertaken directly.

During a step 90, the computer automatically adjusts the duration of the interval ΔT as a function of the value of the previously computed angle θ.

For example, if the value θ is below a predetermined threshold S₄, then the rotation is too small between two images. This increases the noise and therefore the lack of precision in the value of the computed angle θ. To remedy this drawback, the duration of the interval ΔT is then increased.

The duration of the interval ΔT may be increased by skipping acquired images, therefore without modifying the frequency of acquisition of the images by the sensor 8 or, conversely, by slowing the frequency of acquisition of the images by the sensor 8.

Here, the duration of the interval ΔT is increased or decreased or kept constant after each computation of the angle θ so as to keep the computed angle θ between 0.5 and 10° and, preferably, between 0.5 and 5° or between 1 and 3°.

In parallel with step 90, during a step 91, the module 36 controls the screen 4 in such a way as to modify its display as a function of the angle θ and, optionally, of the coordinates C of the centre of rotation that were computed during step 86. Here, the display of the screen 4 is modified so as to rotate an object displayed on the screen, such as a photo, by the angle θ about the coordinates of the centre C. Typically, during this step, the displayed object rotates about an axis perpendicular to the plane of the screen 4.

Thereafter, during a step 92, the sensor 8 acquires a new image after having waited the interval ΔT since the last acquisition of an image. The new acquired image constitutes the new second image while the former second image now constitutes the first image. Thereafter, steps 68 to 92 are repeated. For example, during step 92, only the pixels contained in the window F are acquired by the sensor 8. This then limits the number of pixels to be acquired and therefore the electrical consumption of the sensor 8.

The method of FIG. 4 stops for example when the finger is withdrawn from the face 12.

Numerous other embodiments are possible. For example, the technology used to acquire the image of the pattern may be based on measurements of capacitances or resistances. It may also involve an optical or other technology. The resolution of the sensor 8, is generally greater than 250 or 380 dpi and preferably greater than 500 dpi.

As a variant, the screen and the electronic sensor of the images of the patterns are one and the same. Thus, the acquisition of the angle θ and of the coordinates of the centre C are done by rotating the pattern, that is to say typically the finger, on the surface of the screen. This constitutes a particularly ergonomic embodiment especially for indicating the position along the directions X and Y of the centre of rotation. Indeed, the finger then designates in a natural manner the centre of rotation where it is desired to apply the rotation.

The window F may be horizontal or vertical, or oriented differently.

As a variant, several windows F may be used simultaneously. For example, a vertical window and a horizontal window, both centred on the coarse estimation of the position of the centre of rotation, are used. In this case, the method described previously is implemented once for the vertical window and then a second time for the horizontal window.

The window F does not need to be centred on the centre of rotation in order for the method to operate. Indeed, whatever the position of the window in the image, the method described hereinabove leads to the determination of an angle θ and coordinates of the centre C. However, preferably, the longest axis of the window passes through or at least in proximity to the centre of rotation.

If the sensitive face 12 is relatively small, the window F may be taken equal in size to the face 12. This simplifies the algorithm and the computations. In general, in this case, the angle of rotation alone serves, the centre of rotation being difficult to designate on account of the smallness of the sensor with respect to the finger.

The groups Gᵢ, and therefore the sectors Sᵢ, may overlap. In this case, two groups Gᵢ immediately adjacent along the axis 66 have pixels in common. Conversely, the groups Gᵢ and the sectors Sᵢ may be separated from one another by pixels not belonging to any group Gᵢ. In this case, the pixels of two groups Gᵢ immediately adjacent along the axis 66 are separated from one another by pixels not belonging to any group. This makes it possible in particular to increase the length of the window F without increasing the number of pixels and therefore the number of operations to be carried out to compute the angle θ and the coordinates C of the centre of rotation.

The groups Gᵢ may have different shapes. For example, in another embodiment, each group Gᵢ is a row of pixels parallel to the direction F and whose width is equal to that of the sector Sᵢ.

Other procedures may be implemented to coarsely locate the centre of rotation of the pattern. For example, a coarse estimation of the position of the centre of rotation may be obtained by taking the barycentre of the blocks of pixels having the smallest mean values. This barycentre may be computed by weighting the position of a pixel block by its mean value.

The selection of the zone of interest may be omitted. This will for example be the case if the sensitive active face of the sensor 8 is small and if all the pixels of this face may be used without this requiring significant computing power.

In the previously described embodiment of the method, the displacements dᵢ are not used for the computation of the angle θ or of the coordinates C of the centre of rotation. As a variant, these displacements dᵢ are used for the computation of the coordinates of the centre of rotation.

The coefficients “a” and “b” of the linear regression line may be computed by using another norm or a procedure other than the least squares procedure.

In another embodiment, the arctangent of the slope “a” or at least a finite expansion of the arctangent of the slope “a” is computed to obtain the angle θ. Optionally, this computation is carried out only if the slope “a” exceeds a predetermined threshold. Below this threshold, the angle θ is taken equal to the slope “a”.

The sizes of the sectors Sᵢ are not necessarily all identical. For example, the height of the sectors Sᵢ in proximity to the right and left ends of the window F may be larger than the height of the sectors Sᵢ that are close to the centre of rotation. Indeed, the displacement yᵢ of the group Gᵢ contained in a sector Sᵢ close to an end of the window will probably be larger than that of a group Gᵢ contained in a sector Sᵢ close to the centre of rotation.

The above method has been described in the particular case where the pattern whose rotation is detected is a fingerprint borne by a finger. However, this method can compute an angle of rotation and the coordinates of a centre of rotation on the basis of the rotation of other patterns that can be detected by the sensor 8 and are produced in other materials. For example, the pattern may be found on a material such as fabric or leather. This material may for example be that of a glove worn by the user. In fact, the method described hereinabove applies to any pattern whose acquired image does not exhibit any symmetry of revolution such as is the case for a fingerprint or the texture of some other material such as leather, a fabric or the like. Hence, as a variant, it is also possible to replace the user's finger by another object bearing this pattern. For example, the pattern may be found at the end of a stylus manipulated by the user.

The method previously described applies also to the acquisition of an angle of rotation and of the coordinates of a centre of rotation with the aid of an optical mouse. In this case, the optical mouse is displaced in rotation about an axis perpendicularly to the plane on which it moves. This optical mouse acquires the first and second images of one and the same pattern and the method previously described is implemented to determine on the basis of these images an angle and a centre of rotation. In this case, the pattern is, for example, a part of a mouse mat or of the top of a table. These patterns exhibit, like a fingerprint, contrasted lines or points which make it possible to obtain an image not exhibiting any symmetry of revolution. In the latter embodiment, it is the electronic sensor which is rotated rather than the pattern. However, this in no way changes the method described here.

1-11. (canceled)

12. A method for acquiring an angle of rotation and coordinates of a center of rotation, said method comprising using an electronic sensor, acquiring a first image of a pattern before rotation thereof about an axis perpendicular to a plane of said first image, using said electronic sensor, acquiring a second image of said pattern after rotation of said pattern by a human being with respect to said electronic sensor about said axis perpendicular to said plane of said first image, said second image being formed of pixels recorded in an electronic memory, using an electronic computer, selecting, from said first image, N different groups Gᵢ of pixels, said groups Gᵢ of pixels being aligned along a common alignment axis, each group Gᵢ being associated with a respective ordinate xᵢ along said axis, wherein an index i identifies a group Gᵢ from among said N groups Gᵢ of pixels, computing, for each group Gᵢ, a displacement yᵢ of said group Gᵢ between said first image and said second image in a direction perpendicular to said alignment axis by comparing said first and second images, obtaining a value of said displacement yᵢ by computing a correlation between pixels of said first image belonging to said group Gᵢ and pixels of said second image, and computing an angle of rotation and coordinates of a center of rotation based at least in part on coefficients a and b of a linear regression line that minimizes
$${\sum }_{i = 1}^{i = N} ‖ {y}_{i} - {ax}_{i} - b ‖$$
wherein ∥ . . . ∥ is a norm, and N is a whole number of groups Gᵢ, N being greater than or equal to three.

13. The method of claim 12, further comprising, using said electronic computer, positioning a window at the same place in said acquired images, said window being at least twice as long as it is wide and smaller than each image, and carrying out said computation of each displacement yᵢ by processing solely pixels of said first and second images that are contained within said window.

14. The method of claim 13, wherein said sensor acquires only pixels contained within said window.

15. The method of claim 13, wherein said electronic computer splits said window into at least N sectors Sᵢ, each sector Sᵢ of said first image comprising all pixels of a respective group Gᵢ of pixels, and wherein said electronic computer carries out computation of each displacement yᵢ by processing solely pixels of said first and second images that are contained in a corresponding sector Sᵢ.

16. The method according to claim 12, wherein said electronic computer compares said displacement yᵢ with a predetermined threshold, and if said predetermined threshold is crossed, then said displacement yᵢ and said ordinate xᵢ associated therewith are ignored during computation of said angle of rotation and during computation of said coordinates of said center of rotation, and if said predetermined threshold is not crossed, then said displacement yᵢ and said ordinate xᵢ associated therewith are taken into account for said computation.

17. The method of claim 12, wherein said electronic computer adjusts a time interval between acquisition of said first image and acquisition of said second image as a function of said angle of rotation computed on based at least on one image acquired before said first and second images so as to keep said computed angle of rotation between 0.5° and 10°.

18. A computer readable medium having encoded thereon software comprising instructions for causing said method recited in claim 12 to be executed by an electronic computer.

19. A method for controlling a display screen, said method comprising causing an electronic computer to control said screen so as to rotate an object displayed on said screen as a function of an acquired angle of rotation and of coordinates of a center of rotation, wherein said method comprises acquisition of said angle of rotation by implementing said method recited in claim 12.

20. A computer readable medium having encoded thereon software comprising instructions for causing said method recited in claim 19 to be executed by an electronic computer.

21. An apparatus comprising a screen, an electronic sensor configured to acquire a first image of a pattern before rotation thereof with respect to said electronic sensor, by a human being, about an axis perpendicular to a plane of said first image, and to acquire a second image of said same pattern after said rotation, said first and second images being formed of pixels recorded in an electronic memory, and an electronic computer programmed to control said screen in such a way as to rotate an object displayed on said screen as a function of an acquired angle of rotation and of coordinates of a center of rotation, and to acquire said angle of rotation by selecting, from said first image, N different groups Gᵢ of pixels, said groups Gᵢ of pixels being aligned along a common alignment axis and wherein each group Gᵢ is associated with a respective ordinate xᵢ along said common alignment axis, an index i identifying a group Gᵢ from among said N groups Gᵢ of pixels, by computing, for each group Gᵢ, a displacement yᵢ of said group Gᵢ between said first image and said second image, said displacement being in a direction perpendicular to said alignment axis, wherein computing said displacement comprises comparing said first and said second image, obtaining a value of said displacement yᵢ by computation of a correlation between pixels of said first image belonging to said group Gᵢ and pixels of said second image, and computing said angle of rotation and said coordinates of said center of rotation based at least in part on coefficients a and b of a linear regression line that minimizes
$${\sum }_{i = 1}^{i = N} ‖ {y}_{i} - {ax}_{i} - b ‖$$
wherein ∥ . . . ∥ is a norm, and N is a whole number of groups Gᵢ, N being greater than or equal to three.

22. The apparatus of claim 21, wherein said electronic sensor comprises a fingerprint sensor.

23. The apparatus of claim 21, wherein said electronic sensor comprises an optical mouse.
